(19) United States
(12) Patent Application Publication
(10) Pub. No.: US 2014/0308623 A1
(43) Pub. Date: Oct. 16, 2014

(54) COMPUTER FABRICATION OF DENTAL PROSTHETICS

(71) Applicant: Mun Chang, La Mirada, CA (US)

(72) Inventor: Mun Chang, La Mirada, CA (US)

(21) Appl. No.: 13/862,197

(22) Filed: Apr. 12, 2013

(51) Int. Cl. A61C 13/00; A61C 13/08; A61C 9/00

(52) U.S. Cl. CPC A61C 13/0004; A61C 9/0053; A61C 13/0022; A61C 13/08
USPC 433/29; 433/202.1

(57) ABSTRACT

A method is disclosed to fabricate a dental prosthesis by obtaining an image of the patient's dentition and generating a three-dimensional model of the dentition; positioning a portion of the dentition into a computer model of a mill blank; defining a margin region surrounding a dental object; defining an abutment ditch outside of said margin; generating a milling model having two virtual portions including the margin region and the abutment ditch region; and milling the dental prosthesis with a differential speed, wherein the milling of the abutment ditch portion is done at a higher speed than the milling of the prosthesis portion.

### BACKGROUND

This invention broadly relates to computer-aided design and machining processes to create a dental prosthesis from a mill blank.

A variety of dental procedures are known for replacing or repairing damaged, weakened or missing tooth structures. For example, a dental prosthesis commonly known as a filling is often used to fill cavities in teeth caused by tooth decay or caries. Somewhat larger prosthetics also used to fill cavities are known as inlays and onlays. Fillings, inlays and onlays may also be utilized to restore the shape of teeth that have been chipped or broken. Other types of dental prosthetics include bridges, full crowns and partial crowns. Typically, these prosthetics are much larger than fillings and as a result are often more visible in the oral cavity. Full and partial crowns may be supported by remaining portions of the original tooth structure and/or by a post extending toward the bony region of the jaw. Bridges, on the other hand, are structures that connect to adjacent tooth structure and provide an artificial tooth or tooth crown to replace corresponding, missing structure.

Large prosthetics are often fabricated outside of the oral cavity and then placed in the patient's oral cavity once completed. For these types of prosthetics, an impression is often taken of the patient's tooth structure of interest along with adjacent regions of the gingiva, using an elastomeric impression material that provides a negative physical image of the tooth structure and gingival region. Next, a cast positive model is made by pouring a quantity of plaster of Paris into the impression and allowing the plaster of Paris to harden. The resulting plaster of Paris or “stone” model is then used in the laboratory to make a prosthetic that is ultimately transferred to the patient's oral cavity.

The laboratory procedure for making the prosthetic may be somewhat involved and may require the patient to make multiple visits to the dentist, depending on the type of prosthetic that is needed. In one method, for example, a wax replica of the desired crown is built on the stone model. The wax replica is then embedded in a refractory investment material and fired to create another negative physical image of the oral structure of interest. Porcelain is then forced into the investment material under pressure and heat in order to make the crown.

The fabrication of custom dental crowns and other prosthetics by hand from stone models is an art that involves a high degree of skill and craftsmanship, as well as intensive labor. Moreover, prosthetics that are placed in the anterior regions of the patient's oral cavity are often highly visible. It is widely considered difficult to make porcelain prosthetic that exactly matches the translucency and color of natural teeth.

For the above reasons, increased interest has been directed toward the use of computer automated machinery for fabricating dental prosthetics. Current applications of dental CAD/CAM allow dentists to produce artificial restoration at chair side while patients are waiting at dental clinic (chair side). This technology, along with the development of intra-oral scanner, allows the professionals to make the restoration while the patient is chair side. Intra-oral scanners directly scan patient's mouth to obtain digital impression of patient's mouth and jaw structure. The next step is applying CAD technology to design restoration for missing teeth from the scan file obtained from intra oral scanner. And then finally the designed restorations are milled by CNC milling machine, and then if necessary, dentist do final touch up such as staining, and polishing the restoration to match with existing adjacent teeth.

However, the above newly developed technology have been used only for limited restoration such as single crown for posterior, in-lay, and on-lay, and filling which does not requires any substructure of teeth to support fractural toughness. It has not been used for anterior prosthesis because it requires exact matches the translucency and shape. It also has not been used for bridge due to ceramics milled by chair side system are not strong enough to support the bite. If dentist want to have artificial restoration beyond the chair side system capacity such as PFM (porcelain fused to Metal), PFG (porcelain fused to gold), and PFZ (porcelain fused to zirconia) etc., then dentist has to take conventional impression and send to dental laboratory or send the digital impression to where Rapid Prototype system or other model milling application available in order for dental technician to have replica model of patient mouth to build crown and bridge.

Due to the limitation of chair side system, demands on model duplication from digital files obtained by intra oral scanner have increased. Some companies have attempted to apply Rapid Prototype systems to duplicate and/or print to generate a positive copy of patient's teeth structure, while others have used CNC milling systems.

The Rapid Prototyping system can produce replica model quickly, but it uses materials that can be expensive for dental technician in comparison with conventional impression taken by dentist. Also it is heavy maintenance and its accuracy is not as good as CNC milling system. In addition, Rapid Prototype machine cannot produce zirconia coping or ceramic full crown which are currently produced by CNC milling system. On the other hand, the CNC milling system is limited to one case at a time and it is time consuming due to small size of CNC machine that allow the tool travel area short distance. Thus, if the dentist desires a CAD CAM system that can produce from digital impression to final restoration, a dental CNC milling machine also needed in addition to the Rapid Prototyping system, adding to the cost.

### SUMMARY

In one aspect, a method is disclosed to fabricate a dental prosthesis by obtaining an image of the patient's dentition and generating a three-dimensional model of the dentition; positioning a portion of the dentition into a computer model of a mill blank; defining a margin region surrounding a dental object; defining an abutment ditch outside of said margin; generating a milling model having two virtual portions including the margin region and the abutment ditch region; and milling the dental prosthesis with a differential speed, wherein the milling of the abutment ditch portion is done at a higher speed than the milling of the prosthesis portion.

In another aspect, a system to fabricate a dental prosthesis includes a milling machine and a scanner to obtain an image of the patient's dentition and generating a three-dimensional model of the dentition. A computer is connected to the milling machine and scanner and includes computer code for: positioning a portion of the dentition into a computer model of a mill blank; defining a margin region surrounding a dental object; defining an abutment ditch outside of said margin; generating a milling model having two virtual portions including the margin region and the abutment ditch region; and milling the dental prosthesis with a differential speed, wherein the milling of the abutment ditch portion is done at a higher speed than the milling of the prosthesis portion.

Advantages of the preferred embodiments may include one or more of the following. The combined use of CAD/CAM software and a CNC milling machine provides a fully automated means for directly machining dental prosthesis. This approach allows greater flexibility in producing prosthesis with highly precision shape. The system saves on time, cost, and labor associated with conventional dental prosthesis fabrication techniques. The system allow one system to produce not only a duplication model of patient's mouth from digital scan file, but also it can produce ceramic coping and crown and wax coping and full crown practically without any limitation by changing its worktable only by users. The system also meet the economic and technical demand by small and large dental profession because it allow to produce prosthetics without physical impression taken by dentist. Overall dental prosthesis can be economically produced with the milling/grinding machine in accordance with the preferred embodiments of the invention, in medical, dental-medical and dental-technology, implant parts, inlays, partial crowns, crowns, bridges, prosthetic bases and auxiliary parts, exactly and with high mechanical strength suited to the intended purpose, and of various dental materials.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 and FIGS. 2A-2H illustrate an exemplary process to create a dental prosthesis from a mill blank.

FIG. 3 shows an exemplary worktable with mill blanks on a top side.

FIG. 4 shows an exemplary worktable with mill blanks on both sides.

FIG. 5 shows an exemplary worktable without a plastic clamp to the worktable.

FIG. 6 shows a view of one computer model structure representing a top portion of the mill blank.

FIG. 7 shows a view of two computer model structure representing a top portion of the mill blank next to a bottom portion of the same mill blank or different mill blank.

FIG. 8A shows an exemplary worktable with the clamp only.

FIG. 8B shows an exemplary mounting system to mount the milling blanks to a worktable.

FIG. 8C shows another view of the mounting system.

FIG. 8D shows an exemplary mount used in FIG. 8C.

FIG. 9A and 9B show exemplary methods of applying tool path so as to reduce tool breakage.

FIG. 10 shows an exemplary prosthesis fabrication system.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

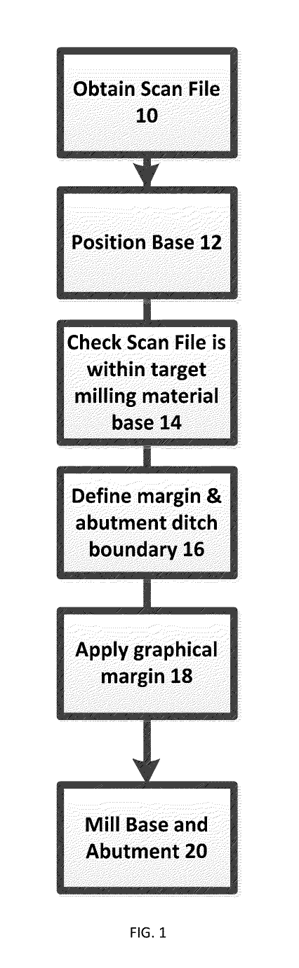

FIG. 1 and FIGS. 2A-2H illustrate an exemplary process to create a dental prosthesis from a mill blank. First, a scanned file of a patient's dentition is captured (10). One exemplary scanned dentition is shown in FIG. 2A. Next, the scan file is attached to a base material computer model (12). This can be done by simply overlaying the scanned file above the base material model. One exemplary attachment of the scanned dentition to the base materials is shown in FIG. 2B. In this example, each of the top and bottom dental arches is attached to a respective base material.

The process then checks to see if the scanned file is enclosed within the target base material (14). This is illustrated in FIG. 2C. FIG. 2D shows one example where the patient dentition model is attached to the base and ready for trimming operations.

Next, the process receives margin and abutment ditch boundary from an operator (16). The operator can draw the shape of the base of the dentition to graphically define each tooth margin. The operator can also define a ditch boundary for abutment between teeth. FIG. 2E shows an example view where the base of each tooth is drawn inside the ditch boundary between abutting teeth.

The process then applies the graphical margin (18). As shown in FIG. 2F, the graphical margin is applied, and the tooth model abutment is separated from the base. FIG. 2G shows empty tooth bases that will be milled thereafter, while FIG. 2H shows completed abutments after the blank has been milled by computer numerical control (CNC) equipment.

One implementation features fast and accurate production. In one embodiment, the system not only duplicates models with precision but also overcomes detrimental issue on milling duplication model by the CNC milling machine. The system reduces milling time which is crucial when model duplication is done by CNC machine. Because the final tool has to be small in diameter which allow to touch each of curved surface of prosthetics, generally and conceptually the smaller diameter tools can produce more detail and accurate duplication. Due to the milling time issues, the following of one or more items are invented to reduce the milling times without losing its accuracy and integrity of final results.

First, during design application, the system separates one actual material body into two independent file, the scan file stay within the top portion of the file and apply milling process only for top portion region except for the abutment ditch area, which is the place that independently milled abutment will be placed after milling process. The system replaces the worktable allows the system to mill not only model duplication but also zirconia or wax or ppma or other ceramic material as needed. The system also saves a preformatted shape of material to be milled (target area) internally in CAD and CAM as exactly same position as actual material place on the machine by name as target 1 or 2 or 3 etc. and it allows any type of shape of material to be milled properly as long as each position and each name are saved internally and indicated in the cam parameter setting,

The system then places several holes to clamp to the machine which also provides guidance of the upper and lower model articulated properly by matching the holes. The independently milled upper and lower jaw should articulated exactly the same as the original scan file and these holes ensures the milled model position would be the same as the original scan file obtained by scanner.

The user can select one or more designs on the back side of plastic with ditch commonly used articulator device and attached. The system then ensures the graphical articulator ditch boundary is cylinder shaped so that the final tool will cover the entire surface of the ditch. Because its two base for articulator design never moves independently during the design process, resulting upper and lower scan files remain same respective X and Y coordinate each other and allow move only Z direction. Therefore, the four plastic holes allow exact matching with the scan files' registration of both low and upper jaw after milling process. In order to keep the each of scan file match the coordinate of plastic, the base of material for both upper and low move and rotate together in order to keep plastic holes remain matched, it is necessary function because low and upper jaws are independently located on the worktable for milling process and these two need to register exactly as same as scan file obtained for both upper and low jaws from either intra oral scanner or model scanner.

Next, the tool path generation is discussed. The user has great flexibility to utilize the system regardless of quantity of workload, by internal placement of material to be milled in the CAD CAM and actual material placement in the machine allow user to apply tool path on its discretion whether there are a few or many of material to be milled, The CAM procedure automatically recognize by its name and its placement. In other words, the cam tool path applies only by its target name, which can modify any type of worktable of the machine and any changes in shape or position of the material can be adequately apply tool path as long as the actual shape and size and position of the material are save in the designated folder by users.

The deep groove shape of human teeth or narrow gap area may cause tool breakage if the final thin tool is used for cutting along the surface. An automatic z level tool path application can be used to get rid of this issue. The system works by finding any of such region automatically and applying incremental z level of tool paths which allow the tool moves as little as parameter in potential tool breakage areas set in the parameter by users.

The CNC can provide simultaneous 5 axis movements. However, such movements take a long time to mill the whole model that is very important detrimental issues model milling by CNC machine. Applying an uncut region will substantially reduce the cutting time which automatically recognize any of surface previous tool could not reached, then only apply tool movement for that particular region by given angle set in the parameter by users. To reduce the cutting time, the system is designed to allow user to mark the certain area on the scan file and particular tool paths will be applied to only marked area which can be also set by the user as one or more parameters.

The dental CNC milling machines are three dimensional mills that move a rotary cutter through an x, y, z axis envelope. A porcelain based raw material blank can be installed in a chuck or fixture within the envelope and the mill head can be moved around the blank to cut and form the blank into a desired shape. The desired shape is usually programmed into the CNC milling machine controller via a CAM based software program. Examples of milling machines that utilize large discs or blocks of a single material into which multiple dental prostheses can be milled include the Weiland ZENO™ milling machine, the Tizian milling machine, and the Katana milling machine. Alternatively, the CEREC milling machine utilizes a single small block in which a single prosthesis is milled.

Once the electronic model for the prosthesis with the graphical margin is completed, the dental appliance may be manufactured using any manufacturing processing that accepts electronic models for physical objects expressed in a standard form as discussed above. In one embodiment, a standard STL specification file is utilized to define the volume for the appliance that is to be manufactured. The STL specification file is used generate an impression for the appliance using a rapid prototyping process that is well known in the prototyping industry. Of course, one skilled in the art will recognize that any type of rapid prototyping methods may be utilized to make such prosthesis without deviating from the spirit and scope of the present invention as recited within the attached claims. In addition to the CNC technique used herein, other alternative fabrication techniques may also include milling of dental appliance materials and use of electrical discharge machining techniques as are well known in the art.

In addition to creating the device as described above, the model for the device may be manually edited or sculpted once created to define the final definition for the appliance before it is fabricated. This sculpting is performed electronically on the electronic model once created where the surface of the computer model is manually moved to change the shape of the application by a dental professional until the desired prosthesis shape is defined. This process is similar to the manual sculpting of physical models that is well known in the profession.

To alter the surface of the computer model, the dental professional defines a point on the surface to be moved and a region of affected surface on the computer model. The region of affected surface is a region of area surrounding the point to be moved. The dental professional then moves the point to a new location and the processing system alters all of the points on the surface of the electronic model within the region of affective surface to create a continuous surface and smooth surface between the point being moved 1241 and the remaining surface of the electronic model.

The fabrication of a dental prosthesis using a computer-aided machining system uses a “mill blank”, a block of material from which the prosthetic is cut. Dental mill blocks are often made of a ceramic material or resinous materials. As used herein “dental mill blank” refers to a solid piece of material from which a restoration, such as a crown or bridge, can be formed by a subtractive milling. As used herein, “milling” refers to abrading, polishing, controlled vaporization, electronic discharge milling (EDM), cutting by water jet or laser or any other method of cutting, removing, shaping or carving material. The milling is generally conducted predominantly by a machine. Blanks may be made in any desired shape or size, including cylinders, bars, cubes, polyhedra, ovoids, and plates. The fabricating a dental restoration from dental mill blanks can include methods with a dental implant abutment integrated therein, dental mill blanks, dental prosthesis, and methods of making dental mill blanks. The preformed dental implant abutment is permanently bonded to a dental mill blank prior to use (e.g. as packaged) or as received by the dental practitioner.

The dental mill blanks can comprise of a variety of materials, provided the material is suitable for use in the oral cavity and is also capable of being milled by a milling machine without undue hindrance or tool wear. Examples of suitable materials include ceramics, polymers, polymer-ceramic composite materials, and metals. Examples of suitable metals include stainless steel, alloys of gold or titanium, palladium-based alloys, nickel-based alloys, cobalt-based alloys or any other alloy suitable for use in the oral environment.

Examples of suitable ceramic materials include glasses, monocrystalline and polycrystalline ceramics, and glasses with crystalline phases. Polycrystalline ceramics include nanocrystalline materials and may be single phase or multiphase. Preferred crystalline ceramic materials include aluminum oxide, magnesium-aluminum spinel (MgAl2O4), zirconium oxide, yttrium aluminum garnet, zirconium silicate, yttrium oxide and mullite. Preferred glass containing materials include feld-pathic porcelains; glasses containing crystalline; phases such as mica, leucite, canasite, alumina, zirconia, spinel, hydroxyapatite; and amorphous glasses available as “Pyrex” and “Vycor” from Corning, Inc., Corning, N.Y.). For ceramic mill blank embodiments, the ceramic may be provided in a fully dense form, with little or no porosity, or in a porous, partially fired form. If the ceramic mill blank is porous, it may be fired to a fully dense state after milling. Alternatively, the porous ceramic mill blank may be infiltrated with, for example, a molten glass or a resin that is then hardened after infiltration.

Preferably, the (e.g. ceramic) mill blank material transmits light in the visible wavelengths in order to provide an aesthetically pleasing appearance once milled into a prosthetic and placed in the oral cavity. Preferably, the (e.g. ceramic) material is essentially colorless; i.e., it neither adds nor subtracts color to the light passing through the material to any appreciable extent. Optionally, however, colorants may be added to achieve desired shades that mimic the color of natural teeth that may be observed in certain patients.

Preferably, the (e.g. ceramic) mill blank material has a Contrast Ratio value less than about 0.7, preferably less than about 0.6, and more preferably less than about 0.5. The Contrast Ratio value can be determined by following the technique described in Section 3.2.1 of ASTM-D2805-95, modified for samples of about 1 mm thick. The Contrast Ratio value is an indication of the level of light transmissivity possessed of the resulting prosthesis.

Preferred polymer-ceramic composite mill blank materials include polymerizable resins having sufficient strength, hydrolytic stability, and non-toxicity to render it suitable for use in the oral environment. Preferably, the resin is made from a material comprising a free radically curable monomer, oligomer, or polymer, or a cationically curable monomer, oligomer or polymer. Alternatively, the resin may be made from a material comprising a monomer, oligomer or polymer comprising a free radically curable functionality and a cationically curable functionality. Suitable resins include epoxies, methacrylates, acrylates and vinyl ethers.

Polymer-ceramic composite mill blank materials comprise thermoplastic and thermosetting polymers. Suitable thermoplastic polymers include acrylic polymers such as polymethylmethacrylate, polycarbonates, nylon, polyetheretherkitone, polyurethanes, polyimides, polyamides, and polyoxymethylene material such as available from Dupont under the trade designation “Delrin”. The polymer material is typically filled with one or more types of inorganic filler as described below.

Polymer-ceramic composite mill blank materials generally comprise an (e.g. inorganic) filler. The filler is preferably a finely divided material that may optionally have an organic coating. Suitable coatings include silane or encapsulation in a polymeric matrix. The filler may be selected from one or more of many materials suitable for incorporation in compositions used for medical or dental applications, such as fillers currently used in dental restorative compositions and the like.

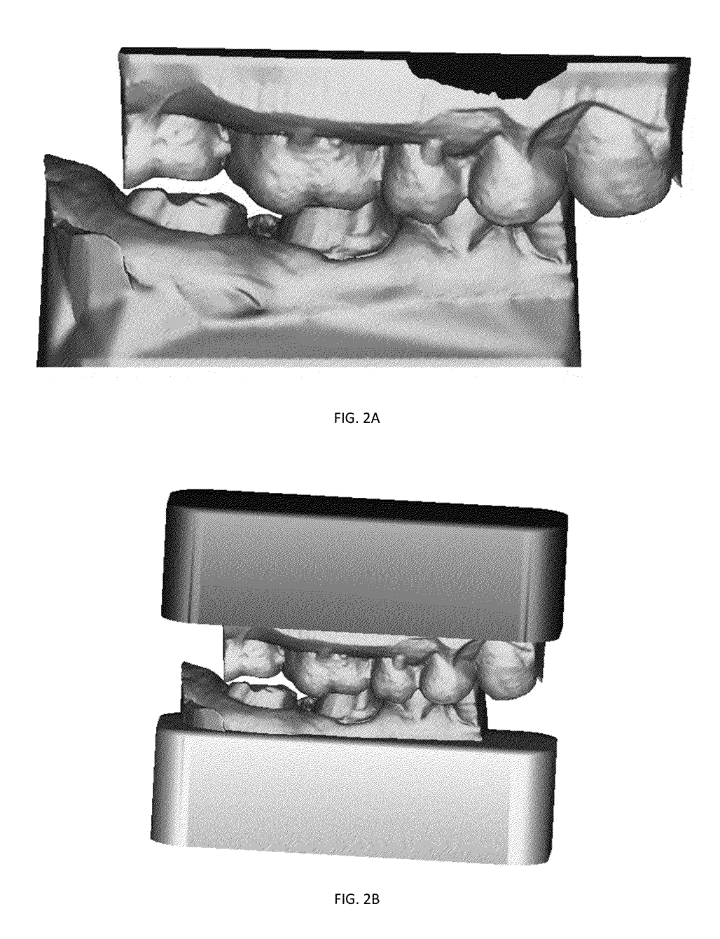

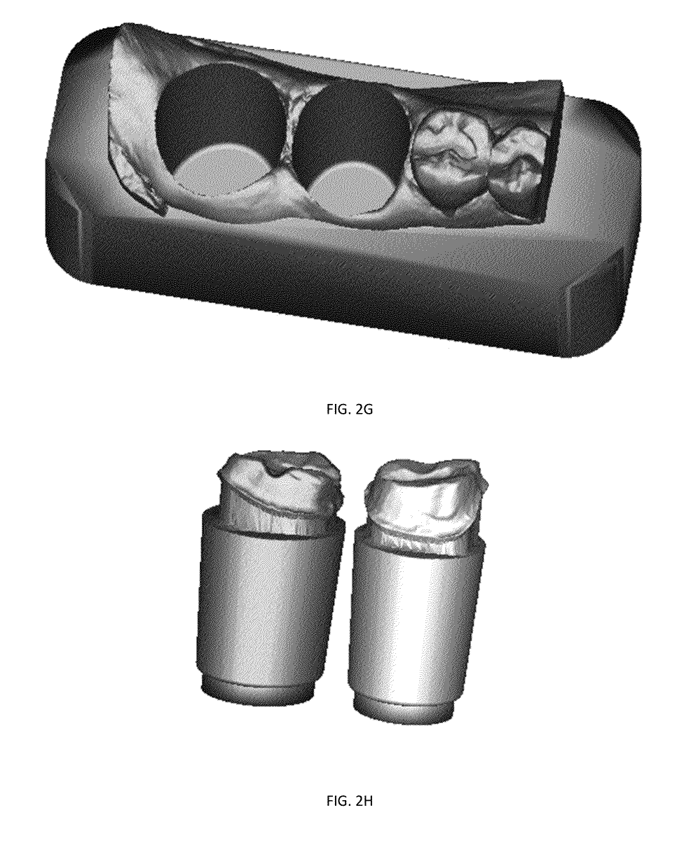

FIG. 3 shows an exemplary worktable with a mill blank on a top side. In FIG. 3, the mill blank 40 has a top portion 42 that includes material to be milled as the prosthetic. The blank 40 also has a bottom portion 44 that includes material to be milled for the abutment ditch only. A plastic clamp 46 which is detailed in FIG. 6 is used to secure the blank 40 to a worktable 48.

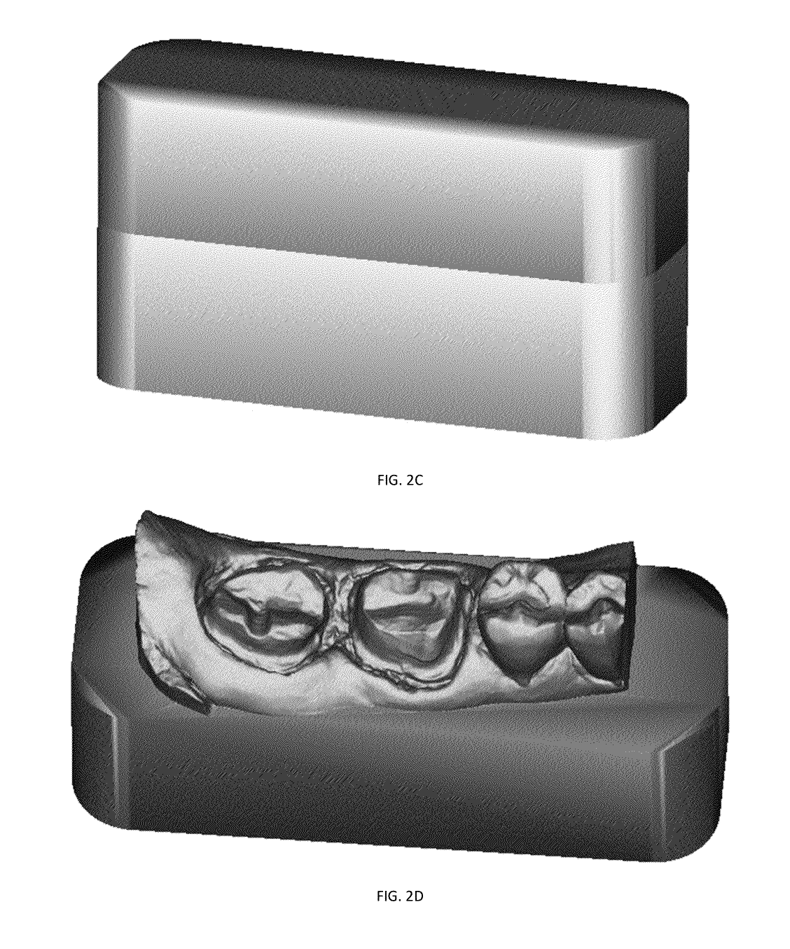

FIG. 4 shows an exemplary worktable with mill blanks on both sides. The CNC can process multiple blanks on top and on bottom of the worktable for efficiency.

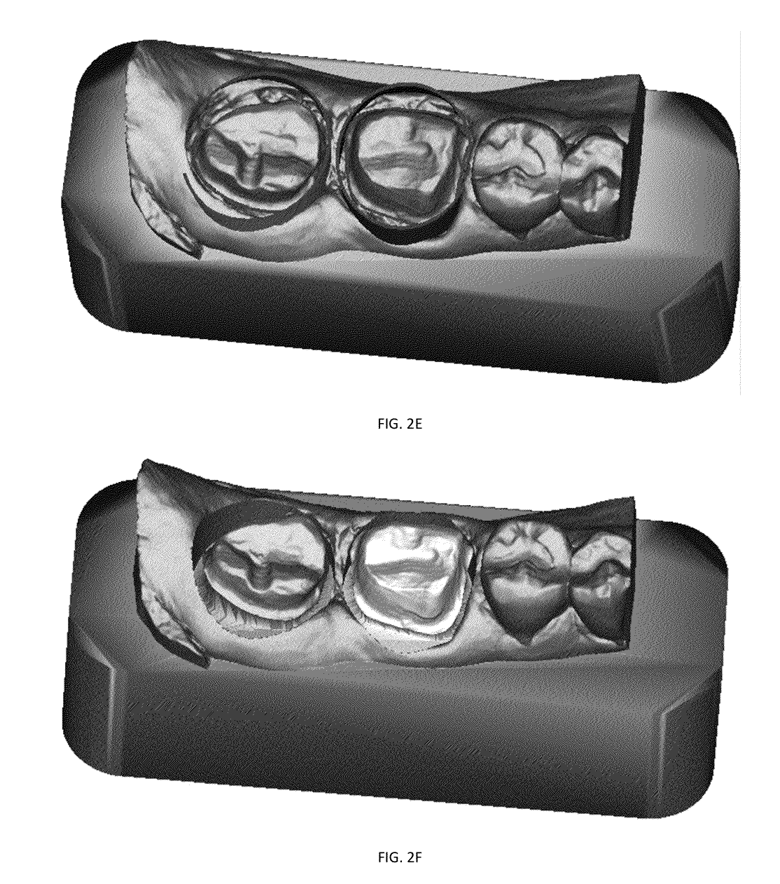

FIG. 5 shows an exemplary worktable without a plastic clamp to the worktable. In this example, an A portion represents the scan file, while a B portion represents the abutment ditch generated using software for graphical margin. The mill blank 40 is a combination of materials A and B as one body, but the software distinguishes the separation as two regions to optimize the cutting time. Thus, during the formation of highly precise dental prosthetics, the CNC is controlled for fine cutting precision. During the formation of the abutment ditch, the CNC can operate faster with the simple shape of the ditch, in one case is a cylindrical shape but other ditch shapes can be formed.

FIG. 6 shows a view of one computer model structure representing a top portion of the mill blank. In this example, the top portion 42 is only shown.

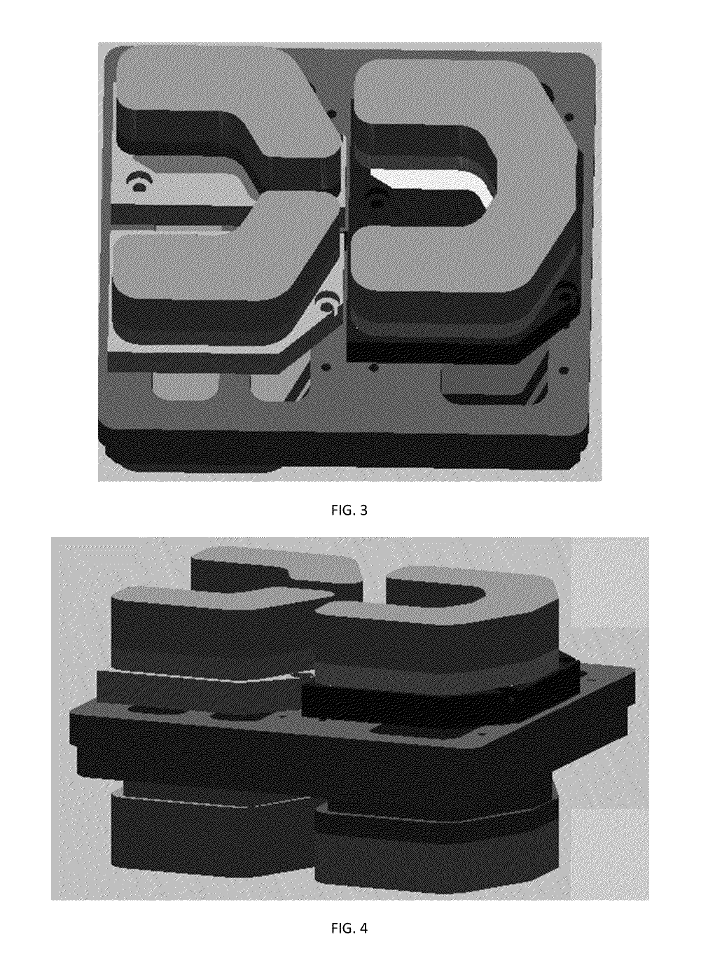

FIG. 7 shows a view of two computer model structure representing a top portion of the mill blank next to a bottom portion of the same mill blank or different mill blank. In this system, the plurality of ceramic millable dental blanks can be disposed in a flat layer with a top and a bottom of each of the plurality of ceramic millable dental blanks unblocked by another of the plurality of ceramic millable dental blanks. The plurality of ceramic millable dental blanks can be obtained with each secured to the worktable. The fixture is secured to a chuck of the milling machine. The dental prosthesis can be wet milled in each of the plurality of ceramic millable dental blanks with a diamond burred cutter. A top side of each of the plurality of ceramic millable dental blanks can be milled; the fixture can be turned over; and an opposite bottom side of each of the plurality of ceramic millable dental blanks can be milled. The plurality of ceramic millable dental blanks is removed from the fixture. In accordance with another aspect of the present invention, the fixture can be interchanged with a single ceramic millable dental blank by removing the fixture from the chuck and securing a post of the single ceramic millable dental blank to the chuck. The single ceramic millable dental blank can be wet milled with the diamond burred cutter. Thus, the system can mill both groups of ceramic blanks, and individual blanks.

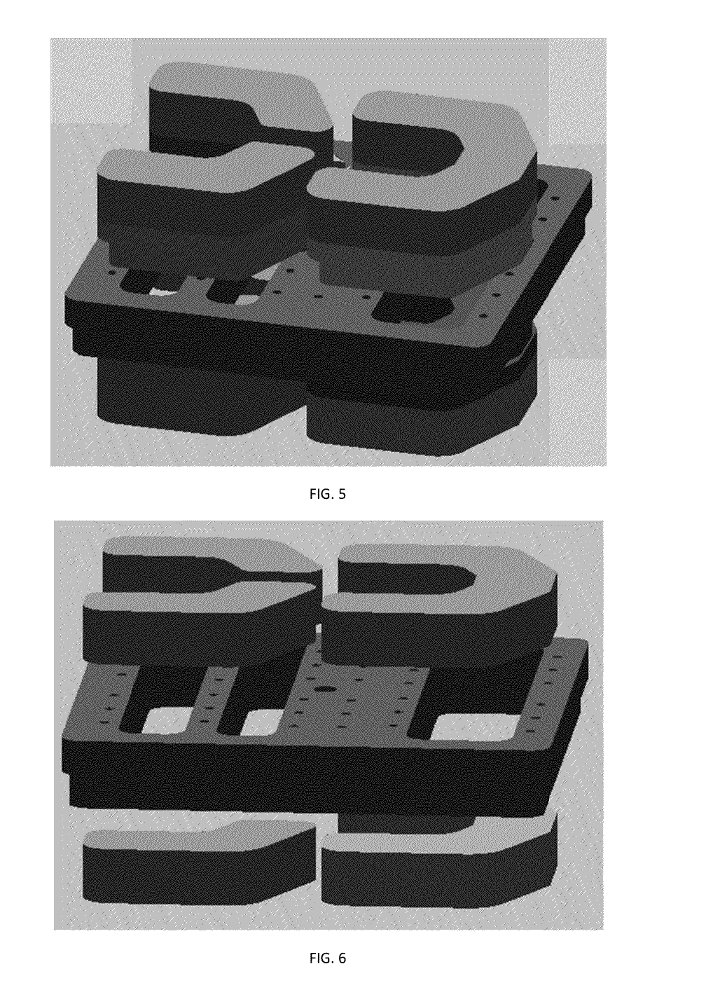

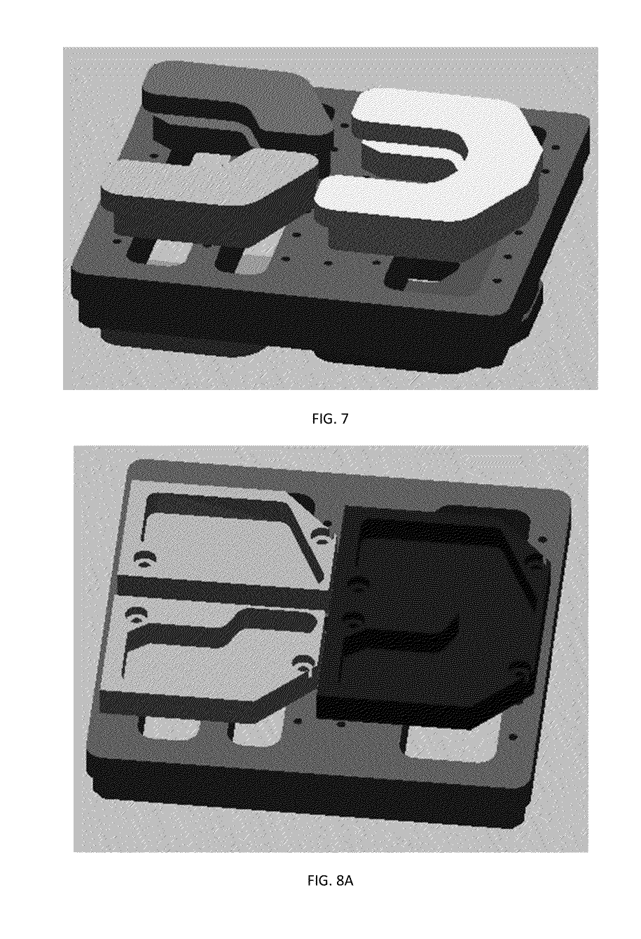

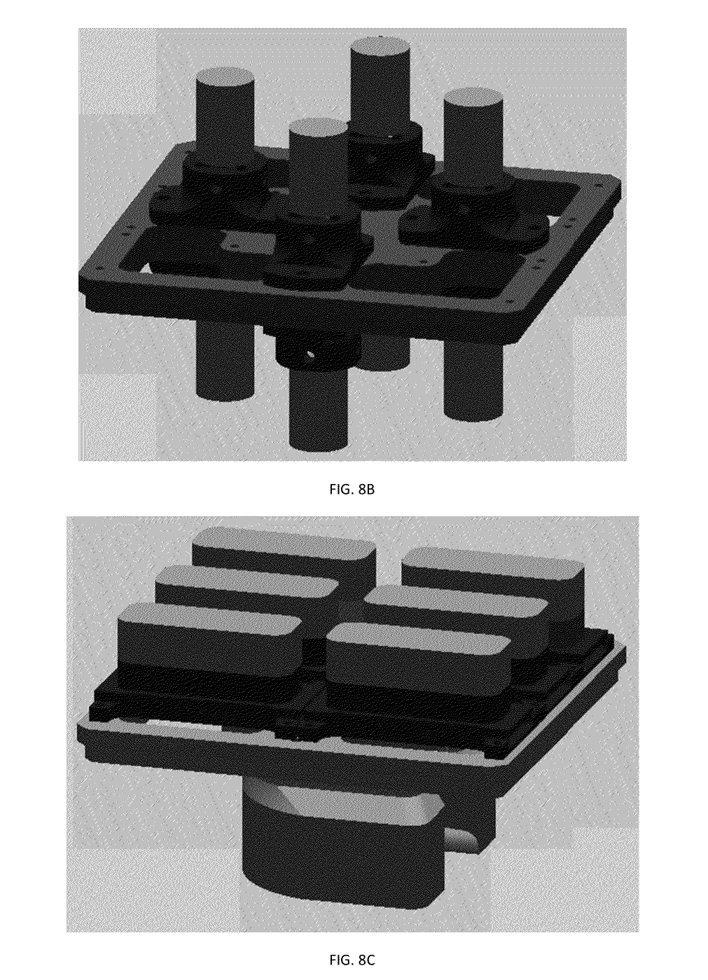

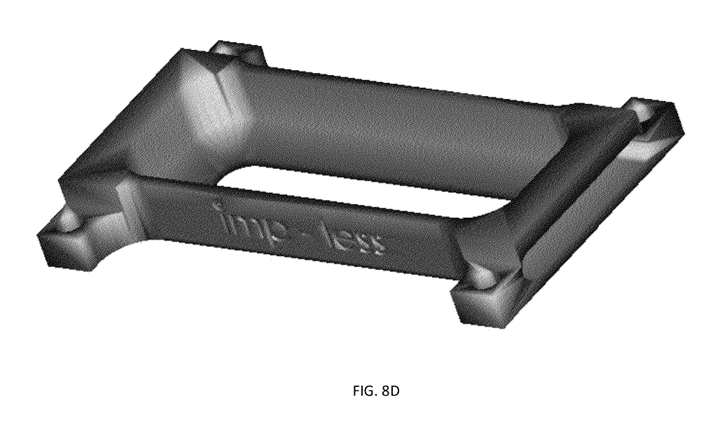

FIG. 8A shows an exemplary worktable with the plastic clamp only. In this example, three clamps 182, 184 and 186 are shown secured to the worktable. The clamps are plastic holders that attach and securely hold the mill blanks to the worktable. The clamp has a U-shaped or arch-shaped depression that is attached to the mill blank. Further, the clamp can be one piece or two pieces as shown in FIG. 8A.

FIG. 8B shows an exemplary mounting system to mount the milling blanks to a worktable. The milling blank is secured to an abutment holder that is attached to the worktable. The abutment holders can be positioned on both sides of the worktable to improve milling speed. Further, the milling blank is mounted with the margin trim abutment next to the abutment holder.

FIG. 8C shows another view of the mounting system. In this system, the user can place various milling blank shapes as long as the shapes are referenced by a file name so that the tool path will only operate on an indicated target area. In FIG. 8C, the denture material is mounted on the bottom face of the worktable, while the material for quadrant bite are mounted on top of worktable.

FIG. 8D shows an exemplary mount used in FIG. 8C. As shown therein, the mount has an access ditch that allows the dentist or dental professional to use available articulator products so that the dentist can view the articulation of the upper and lower jaws before installing the prosthesis on the patient.

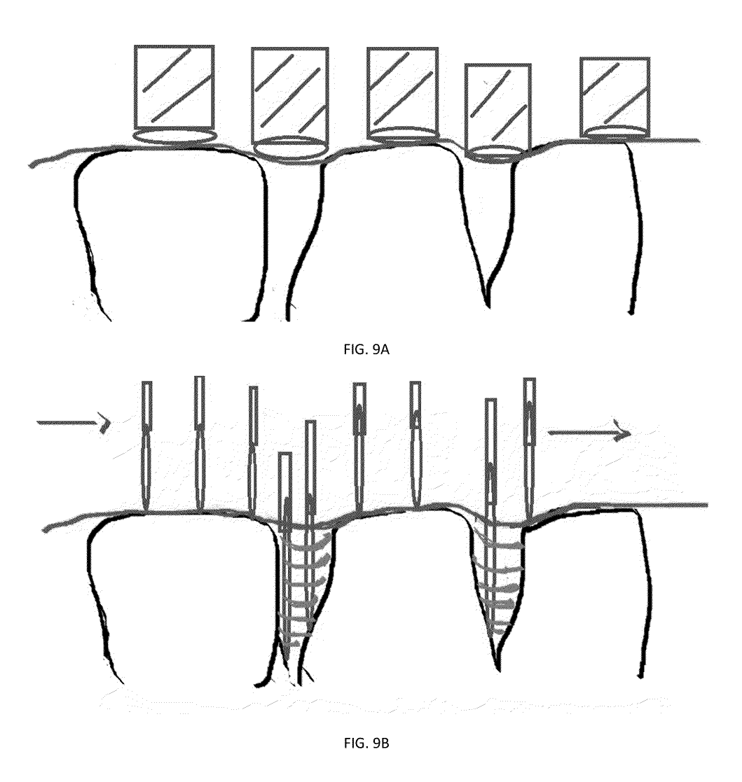

FIG. 9A and 9B show exemplary methods of applying tool path so as to reduce tool breakage. In FIG. 9A, a roughing tool is applied to the top of the milled tooth regions. However, regions A and B between teeth cannot be removed by the roughing tool due to the large diameter of the roughing tool. In FIG. 9B, a finer finishing tool can be applied that follows the surface. However, the tool may break at regions A and B due to inconsistency of leftover material to be removed. The tool-path would automatically control the z level incremental force before the finishing tool path applies a function to speed up the finishing tool without tool breakage.

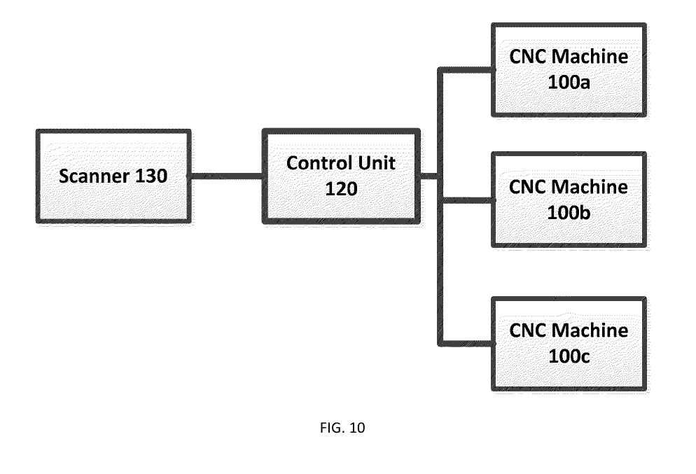

Referring to FIG. 10, a preferred embodiment of a system of the instant invention is shown in which a plurality of cutting machines 100a, 100b and 100c are connected to central control unit 120. Control unit 120 is connected to scanner 130. Each of machines 100a, 100b and 100c include cutting tools 112, laser engraving units 114, and automatic blank feeders 116. Mill blanks with various shapes and sizes are loaded into machines 100a, 100b and 100c

The resulting milling sections are suitable for fabricating a wide variety of restorations, including inlays, onlays, crowns, veneers, bridges, implant abutments, copings and bridge frameworks. Various means of machining the milling section may be employed to create a custom-fit dental prosthesis having a desired shape.

By using a CAD-CAM milling device, the prosthesis can be fabricated efficiently and with precision. During milling, the contact area between the milling tool and the milling section may be dry, or it may be flushed with or immersed in a lubricant. Alternatively, the contact area may be flushed with an air or gas stream. Suitable liquid lubricants are well known and include water, oils, glycerin, ethylene glycose and silicones. After milling, some degree of finishing, polishing and/or adjustment may be necessary to obtain a custom fit into the oral cavity and/or present a desired aesthetic appearance.

In operation, control unit 120 receives specifications for a dental prosthetic that is to be formed from scanner 130. Scanner 130 may be located in close proximity to control unit 120 and machines 100a, 100b and 100c. Alternatively, scanner 130 may be located remote from control unit 120, such as in a dental office or lab, and control unit 120 and machines 100a, 100b and 100c may be located in a central factory or manufacturing center. In the embodiment shown in FIG. 1, scanner 130 is a stand-alone scanner already available in the art and may include appropriate CAD/CAM software for obtaining specifications for a piece that is to be cut (either internally to the scanner or in a computer to which the scanner is connected). In such an embodiment, the dental professional will use the scanner to obtain specifications for the piece that is to be manufactured and transmit the specifications electronically (such as via modem) to the central factory.

In another embodiment, the method can further include obtaining an image of the patient's teeth, such as with an intra-oral scan or based on a stone model. CAD software is used to design a dental prosthesis. CAM software is used to control a cutting tool of milling machine that mills a ceramic blank placed in the milling machine to obtain a dental prosthesis.

The combined use of CAD/CAM software and a CNC milling machine provides a fully automated means for directly machining dental prosthesis. This approach allows greater flexibility in producing prosthesis with highly precision shape. The system saves on time, cost, and labor associated with conventional dental prosthesis fabrication techniques. Overall there can thus be economically produced with the milling/grinding machine in accordance with the preferred embodiments of the invention, in medical, dental-medical and dental-technology, implant parts, inlays, partial crowns, crowns, bridges, prosthetic bases and auxiliary parts, exactly and with high mechanical strength suited to the intended purpose, and of various dental materials. A further advantage is that the producer of the prosthetic parts can continue to employ his previous auxiliary work materials, known to him in their processing. It is further possible flexibly exploit the machine capacity through the variable employment possibilities of the machine with regard to workpiece quantities and workpiece dimensions. The consequence thereof is a significant reduction of wasted time and an improved exploitation of the machine capacity and an increase of the process reliability. The employment of the milling/grinding machine is thereby not restricted to the working of ceramics, rather all other dental materials can be worked.

The scanning of patient teeth can be done in various ways. Scanners that can determine the surface contour of objects by non-contact optical methods has become increasingly important in many applications including the in vivo scanning of dental structures to create a 3D model. Typically, the 3D surface contour is formed from a cloud of points where the relative position of each point in the cloud represents an estimated position of the scanned object's surface at the given point.

One basic measurement principle behind collecting point position data for these optical methods is triangulation. In triangulation, given one or more triangles with the baseline of each triangle composed of two optical centers and the vertex of each triangle being a target object surface, the range from the target object surface to the optical centers can be determined based on the optical center separation and the angle from the optical centers to the target object surface. If one knows the coordinate position of the optical centers in a given coordinate reference frame, such as for example a Cartesian X,Y,Z reference frame, than the relative X, Y, Z coordinate position of the point on the target surface can be computed in the same reference frame.

Triangulation methods can be divided into passive triangulation and active triangulation. Passive triangulation (also known as stereo analysis) typically utilizes ambient light and the optical centers along the baseline of the triangle are cameras. In contrast, active triangulation typically uses a single camera as one optical center of the triangle along the baseline and, in place of a second camera at the other optical center, active triangulation uses a source of controlled illumination (also known as structured light).

Stereo analysis is based upon identifying surface features in one camera image frame that are also observed in one or more image frames taken at different camera view positions with respect to the target surface. The relative positions of the identified features within each image frame are dependent on the range of each of the surface features from the camera. By observing the surface from two or more camera positions the relative position of the surface features may be computed.

Stereo analysis while conceptually simple is not widely used because of the difficulty in obtaining correspondence between features observed in multiple camera images. The surface contour of objects with well-defined edges and corners, such as blocks, may be rather easy to measure using stereo analysis, but objects with smoothly varying surfaces, such as skin or tooth surfaces, with few easily identifiable points to key on, present a significant challenge for the stereo analysis approach.

To address this challenge, fixed fiducials or a formed pattern such as dots may be placed on a target object's surface in order to provide readily identifiable points for stereo analysis correspondence. WO 98/48242 entitled METHOD AND DEVICE FOR MEASURING THREE-DIMENSIONAL SHAPES by Hans Ahlen, et. al., the content of which is incorporated by reference, discloses a method for measuring the shape of an object by first applying a pattern of paint to the object's surface and then observing the object from a multitude of positions. The pattern of paint is used in conjunction with the multiple images to perform a stereo analysis to calculate the shape of the target object's surface.

Active triangulation, or structured light methods, overcomes the stereo correspondence issue by projecting known patterns of light onto an object to measure its shape. The simplest structured light pattern is simply a spot of light, typically produced by a laser. The geometry of the setup between the light projector and the position of the camera observing the spot of light reflected from the target object's surface enables the calculation of the relative range of the point on which the light spot falls by trigonometry. Other light projection patterns such as a stripe or two-dimensional patterns such as a grid of light dots can be used to decrease the required time to capture the images of the target surface.

The measurement resolution of the target objects' surface features using structured lighting methods is a direct function of the fineness of the light pattern used and the resolution of the camera used to observe the reflected light. The overall accuracy of a 3D laser triangulation scanning system is based primarily upon its ability to meet two objectives: 1) accurately measure the center of the illumination light reflected from the target surface and 2) accurately measure the position of the illumination source and the camera at each of the positions used by the scanner to acquire an image.

To achieve the second objective, commercial 3D scanners typically utilize precision linear or rotational stages to accurately reposition either the illuminator/camera pair or the target object between image acquisitions. However, a variety of real-world situations such as 3D imaging of intra oral human teeth do not lend themselves to the use of conventional linear or rotational stages. Further, the great range in sizes and shapes of the human jaw and dentition make the use of a single fixed path system impractical.

The 3D scanner systems can accommodate the variety of human dentition by incorporating an operator held, wand type scanner. In these systems, the operator moves the scanner over the area to be scanned and collects a series of image frames. In this case however, there is no known positional correspondence between image frames because each frame is taken from an unknown coordinate position that is dependent upon the position and orientation of the wand at the instance the frame was taken. These handheld systems must therefore rely on scene registration or the application of an accurate set of fiducials over the area to be scanned. For example, U.S. Pat. No. 6,648,640 entitled INTERACTIVE ORTHODONTIC CARE SYSTEM BASED ON INTRA-ORAL SCANNING OF TEETH by Rudger Rubbert et. al., the content of which is incorporated by reference, discloses a scanner which acquires images of the denture which are converted to three-dimensional frames of data. Pattern recognition can then be used to register the data from several frames to each other to provide a three-dimensional model of the teeth. United States Patent Application 20060154198 by Duane Durbin et al, the content of which is incorporated by reference, discloses systems and methods for optically imaging a dental structure within an oral cavity by moving one or more image apertures on an arm coupled to a fixed coordinate reference frame external to the oral cavity; determining the position of the one or more image apertures using the fixed external coordinate reference frame; capturing one or more images of the dental structure through one or more of the image apertures; and generating a 3D model of the dental structure based on the captured images.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein. The foregoing description of the exemplary embodiments of the system has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing a method, apparatus, and article of manufacture for constructing dental crowns, bridges and implants.

While the above embodiments of the present invention describe a system and method for constructing dental crowns, bridges and implants using a CNC machine, one skilled in the art will recognize that other methods of manufacture of the dental devices are possible. The present invention allows fabrication of fixed and removable prosthodontic prosthesis such as copings, crowns, inlays, onlays, veneers, bridges, frameworks, implants, abutments, surgical stents, full or partial dentures and other hybrid fixed prosthesis for dental applications. One skilled in the art will easily recognize that other CBI and orthodontic appliances may readily be constructed in accordance of the present invention. As such, long as the manufacturing process utilizes electronic models for impressions of patient's teeth and corresponding electronic models for the crown devices, the present invention to would be useable in other manufacturing methodologies. It is to be understood that other embodiments may be utilized and operational changes may be made without departing from the scope of the present invention.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

The foregoing and other advantages are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other advantages of this invention will become apparent from the following description taken in connection with the accompanying drawings, wherein is set forth by way of illustration and example, an embodiment of this invention and various features thereof.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims. It is also to be understood that the following claims are intended to cover all of the generic and specific features of the invention herein described, and all statements of the scope of the invention which, as a matter of language, might be said to fall therebetween.

What is claimed is:

1. A method to fabricate a dental prosthesis, comprising:
obtaining an image of the patient's dentition and generating a three-dimensional model of the dentition;
positioning a portion of the dentition into a computer model of a mill blank;
defining a margin region surrounding a dental object;
defining an abutment ditch outside of said margin;
generating a milling model having two virtual portions including the margin region and the abutment ditch region; and
milling the dental prosthesis with a differential speed, wherein the milling of the abutment ditch portion is done at a higher speed than the milling of the prosthesis portion.

2. The method of claim 1, comprising modeling the mill blank having a virtual demarcation with a prosthesis portion and a abutment ditch portion.

3. The method of claim 1, comprising securing a mill blank to a working table using a plastic base, wherein the plastic base has an arch shape depression to receive the mill blank.

4. The method of claim 1, comprising securing a mill blank to a working table using a plastic base having two separate portions each secured to the worktable and in combination the two portions secure the mill blank.

5. The method of claim 1, comprising securing a plurality of mill blanks to the top and bottom of a working table.

6. The method of claim 1, wherein the milling blank shape is selected from a group consisting of arch, cylinders, bars, cubes, polyhedra, ovoids, and plates.

7. The method of claim 1, comprising milling a plurality of milling blanks in one session, wherein the blanks are mounted on both sides of a worktable.

8. The method of claim 1, wherein the dental object comprises one of: tooth,

9. The method of claim 1, comprising controlling a cutting tool of milling machine that mills a ceramic blank placed in the milling machine to obtain a dental prosthesis.

10. The method of claim 1, comprising scanning the patient's dentition with an intra-oral scanner or a stone model.

11. The method of claim 1, comprising internally separating top and bottom portions of the milling blank for fast cutting by allowing the top portion for the prosthetic and the bottom portion for the abutment ditch.

12. The method of claim 11, comprising attaching the top and bottom portions to allow proper articulation after independently milling the upper and low portions.

13. The method of claim 1, comprising applying a tool path strategy to prevent tool breakage and fast production with accurate result.

14. The method of claim 13, wherein the tool path strategy includes uncut region finding, marking the area, finding a deep area.

15. A system to fabricate a dental prosthesis, comprising:
a milling machine;
a scanner to obtain an image of the patient's dentition and generating a three-dimensional model of the dentition; and
a computer coupled to the milling machine and scanner, the computer including computer code for:
positioning a portion of the dentition into a computer model of a mill blank;
defining a margin region surrounding a dental object;
defining an abutment ditch outside of said margin;
generating a milling model having two virtual portions including the margin region and the abutment ditch region; and
milling the dental prosthesis with a differential speed, wherein the milling of the abutment ditch portion is done at a higher speed than the milling of the prosthesis portion.

16. The system of claim 11, comprising code for modeling the mill blank having a virtual demarcation with a prosthesis portion and a abutment ditch portion.

17. The system of claim 11, comprising code for securing a mill blank to a working table using a plastic base, wherein the plastic base has an arch shape depression to receive the mill blank.

18. The system of claim 11, comprising code for securing a mill blank to a working table using a plastic base having two separate portions each secured to the worktable and in combination the two portions secure the mill blank.

19. The system of claim 11, comprising code for securing a plurality of mill blanks to the top and bottom of a working table.

20. The system of claim 11, comprising code for milling a plurality of milling blanks in one session, wherein the blanks are mounted on both sides of a worktable.
